(19) United States
(12) Patent Application Publication
(10) Pub. No.: US 2025/0229916 A1
(43) Pub. Date: Jul. 17, 2025

(54) MULTICOPTER

(71) Applicant: Rotors, Drones & More, Stuttgart (DE)

(72) Inventor: Christian Molter, Stuttgart (DE)

(73) Assignee: Rotors, Drones & More, Stuttgart (DE)

(21) Appl. No.: 19/171,143

(22) Filed: Apr. 4, 2025

Related U.S. Application Data
(63) Continuation of application No. PCT/EP2023/078346, filed on Oct. 12, 2023.

(30) Foreign Application Priority Data
Oct. 12, 2022 (DE) 10 2022 126 535.8

(51) Int. Cl. B64U 10/14; B64C 11/34; B64U 40/10

(52) U.S. Cl. CPC B64U 10/14; B64C 11/34; B64U 40/10

(57) ABSTRACT

A multicopter is disclosed including a plurality of rotor devices, where a rotor device has at least one rotor blade which is rotatable about a rotor blade axis. The rotor device further includes a first section rotatably driven about an axis of rotation and a second section which is movable relative to the first section about an axis running parallel to the axis of rotation and to which the rotor blade is attached or which includes the rotor blade. A relative position of the second section in relation to the first section depends on a torque with which the first section is driven and a mechanical coupling which couples the relative position of the first section relative to the second section to a rotational position of the rotor blade about the rotor blade axis.

### CROSS-REFERENCE TO RELATED APPLICATIONS

This continuation application claims priority to PCT/EP2023/078346 filed on Oct. 12, 2023 which has published as WO 2024/079265 A1 and also the German application number DE 10 2022 126 535.8 filed on Oct. 12, 2022, the entire contents of which are fully incorporated herein with these references.

### DESCRIPTION

### Field of the Invention

The invention relates to a multicopter.

### Background of the Invention

Drones in the form of multicopters, usually with four rotor devices, are known on the market. Each rotor device comprises a rotor shaft driven by an electric motor, a rotor head coupled to the rotor shaft, and at least two rotor blades fastened to the rotor head. The known multicopters are usually controlled by changing the rotational speed of the rotor devices, since this can be achieved with few movable parts. In such a case, the propellers can be rigid; only some electronics are needed to control the motor. Wu, Xionan, 2018, “Design and development of variable Pitch Quadcopter for long endurance flight,” Master's Thesis, Oklahoma State University, describes the use of actuators in a multicopter for actively controlling the position of the rotor blades about a rotor blade axis, i.e., to control the angle of attack of the rotor blades. Adjustable pitch propellers are also known—for example, from EP 0 589 338 A1 and from U.S. Pat. No. 1,864,045 A.

US 2018/0002008 A1 relates to a thrust-generating rotor arrangement with which a driven rotor shaft arrangement is connected to a rotor blade arrangement.

The connection is designed in such a way that a spring element between the rotor shaft arrangement and the rotor blade arrangement allows a proportional relative twisting between the rotor shaft arrangement and the rotor blade arrangement with respect to the longitudinal axis of a rotor shaft depending upon the applied drive torque, wherein a rotor blade pitch angle is not changed.

The connection is further designed in such a way that a damping element translates a twisting between the rotor shaft arrangement and the rotor blade arrangement caused by a sudden change in the drive torque into a change in the rotor blade pitch angle for the purpose of cyclical blade adjustment, while the same damping element at best prevents (or limits) a translation of the resulting twisting to the blade pitch angle in the event of a slow and/or permanent adjustment of the drive torque. The slow/permanent changes can be used to adjust the rotor rotational speed (and thus the generated rotor thrust).

EP 3 405 390 B1 relates to a control system for the cyclical change in the pitch angle of a thrust-generating rotor arrangement. The thrust-generating rotor arrangement is based upon the principle presented in US 2018/0002008 A1.

In addition, an amplification effect is generated through controlled use of resonance, as a result of which substantial changes in the blade pitch angle can be achieved even with comparatively small, sudden changes in the drive torque. EP 3 405 390 B1 can be considered a further development of US 2018/0002008 A1.

EP 3 495 265 A1 describes a thrust-generating rotor arrangement with a transmission unit for a drive torque, which is firmly connected to a driven rotor shaft. A rotor head, on which rotor blades are arranged, is arranged on the rotor shaft so as to be twistable relative to the rotor shaft's longitudinal axis. A pitch angle control unit connects the transmission unit for the drive torque to the rotor blades or to control collars/control sleeves of the rotor blades by means of control rods.

The pitch angle control unit serves both to transmit the drive torque to the rotor head and to translate a change in the drive torque into a change in the pitch angle of the blades.

DE 10 2004 032 530 A1 describes a rotary-wing aircraft having a thrust-generating rotor arrangement, wherein a cyclical and/or non-cyclical change in a drive torque causes a movement, resulting from the suspension or design of the rotor arrangement, for influencing aerodynamic forces on the rotor.

In one design variant, an outer part of the rotor arrangement can be twisted to a limited extent relative to a driven rotor shaft. A relative twisting of the rotor shaft and the outer part that occurs when the drive torque changes is translated into a change in the pitch angle of the rotor blades.

U.S. Pat. No. 2,075,682 A describes an adjustable pitch propeller. A propeller hub is arranged to be movable to a limited extent both about the longitudinal axis of a drive shaft and along the longitudinal axis of the drive shaft. The change in the pitch angle of the propeller blades is carried out in each case about a pivot point that is spaced apart from the longitudinal axis of the respective propeller blades. The drive torque of the drive shaft is transmitted to the propeller hub via a lever system—also through the pivot point.

Due to a corresponding arrangement of the components of the adjustable pitch propeller, the pitch angle of the propeller blades is automatically set to an optimal level depending upon the system of applied forces, which is derived from the drive torque and the respective flow conditions.

### SUMMARY OF THE INVENTION

The object of the present invention is to create a multicopter that produces little noise during operation, can be dynamically controlled, is easy to produce, and is highly efficient.

This object is achieved by a multicopter having the features of claim 1. Advantageous further developments are mentioned in subclaims.

The invention solves the above problem by means of a multicopter having a mechanical automatic system for coupling the drive torque to the blade angle of attack in rotor devices, i.e., a blade angle adjustment or an adjustment of the rotational position or the angle of attack of the rotor blades about the rotor blade axis, which does not require active actuators and functions automatically and solely on the basis of the torque applied to the rotor shaft or a change in torque. This makes it possible to equip the multicopter according to the invention with rotor devices that have a comparatively large diameter and thus have a comparatively large rotor circular area. As a result, the power required to generate a certain thrust is reduced, thereby improving the efficiency of the rotor devices. Thanks to the invention, a longer flight time can be achieved with the same battery capacity. In addition, noise emissions decrease with a larger diameter of the rotor devices and the associated lower rotational speeds. Thus, the multicopter according to the invention is particularly quiet.

In concrete terms, the aforementioned advantages are realized by a multicopter comprising a plurality of rotor devices. The term “multicopter” is by no means limited to unmanned aircraft, but also includes manned aircraft, such as E-VTOL aircraft. Typically, such a multicopter comprises two or more rotor devices. A rotor device comprises, for example, a rotor shaft driven by an electric motor and more or less vertically aligned in the normal operating position of the multicopter. The rotor device can further include a rotor head coupled to the rotor shaft. Typically, in the normal operating position of the multicopter, the rotor head is arranged at an upper end of the rotor shaft.

The rotor device further comprises at least one rotor blade that extends radially outwards. The rotor blade can rotate about a rotor blade axis, as a result of which the angle of attack of the rotor blade can be changed. The rotor blade axis can be understood as a longitudinal axis of the rotor blade at least in the region in which the rotor blade is fastened (“root”). The rotor blade itself can extend substantially straight radially outwards, so that its longitudinal axis is also straight. However, slightly sickle-shaped rotor blades are also known, with the protruding end being slightly curved.

With the multicopter according to the invention, the rotor device has a first portion that is driven to rotate about an axis of rotation and a second portion that is movable relative to the first portion about an axis that runs parallel to the axis of rotation. Typically, the two portions are arranged coaxially with one another, but other configurations are also conceivable. The rotor blades are fastened to the second movable portion, which can thus be twisted at least to a certain extent relative to the first portion. A relative position of the second portion to the first portion depends upon a torque with which the first portion is driven and set in rotation.

However, the two portions are not completely independent of one another, because the rotor device comprises a mechanical coupling that couples the relative position of the first portion relative to the second portion to a rotational position of the rotor blade about its rotor blade axis. Thus, the mechanical coupling in question couples an input variable (relative position of the portions) to an output variable (rotational position of the rotor blade). As soon as the relative position of one portion to the other portion changes, the rotational position of the rotor blade about the rotor blade axis, i.e., the angle of attack of the rotor blade, also changes.

If the torque acting upon the first portion is increased during operation of the multicopter, in particular, quickly or even abruptly—this leads, due to the inertia of the second portion with the rotor blade and due to the aerodynamic drag force, acting against the direction of rotation, to a leading twisting of the first portion relative to the second portion in the direction of rotation of the first portion, which increases the angle of attack of the rotor blade and thus the thrust generated by the rotor device. As a result, the aerodynamic drag increases, as a result of which the increase in rotational speed is kept minimal or may even be substantially prevented.

Due to the adaptive propeller structure having flexible elements, an automatic mechanical coupling of the blade angle of attack to the applied motor torque is achieved. Thus, the control of the multicopter can be carried out as usual exclusively via the engine power. However, if the engine power is increased, more thrust is immediately available, since the rotational speed of the propellers does not have to increase first. This is, in particular, advantageous for large propellers with high moment of inertia, which would otherwise require a long time to accelerate.

It is provided that the rotor device comprise a restoring device that at least temporarily presses the rotor blade in the direction of an initial position with regard to its rotational position, wherein the restoring device is in the form of an elastic coupling device that elastically couples the second portion to the first portion. The elastic coupling is provided in the direction of rotation or against the direction of rotation of the first portion. Thus, the relative twisting of one portion to the other portion occurs against a restoring force or against a restoring torque. As a result, the operation of the multicopter according to the invention is further improved.

In a further development of this, it is provided that the elastic coupling device comprise at least one elastic bending element, in particular, comprise a plurality of elastic bending elements, that are arranged in a manner evenly distributed as seen in the circumferential direction of the rotor head, wherein the bending element or elements is or are connected at one end to the first portion and at the other end to the second portion. This is a structurally simple solution. Alternatively, a spiral spring arranged coaxially with the axis of rotation could be provided as a coupling device, or a tubular elastomer body arranged coaxially with the axis of rotation could be comprised by the coupling device. Furthermore, a bending element extending in the radial direction is also conceivable.

A linear spring characteristic curve allows the rotational speed to be kept more or less constant even if the torque increases abruptly. With a suitably dimensioned progressive characteristic curve, the stabilization of the rotational speed is further improved, up to an at least approximately constant rotational speed. It is provided that the elastic coupling device have a progressive spring characteristic curve.

In a further development, it is provided that the rotor device comprises a first stop that at least indirectly limits a rotational movement of the rotor blade about the rotor blade axis in the direction of “smaller angle of attack.” As a result, the reliability of the multicopter during operation is improved, since any torsional vibrations that may occur between the two portions of the rotor device cannot cause the angle of attack to fall below a defined minimum value.

In a further development, it is provided that the rotor device comprises a second stop that limits a rotational movement of the rotor blades about the rotor blade axis in the direction of “larger angle of attack.” This also improves the reliability of the multicopter during operation, since a defined maximum angle of attack cannot be exceeded in the event of torsional vibrations occurring between the two portions of the rotor device or in the event of a strong increase in the torque acting upon the first portion of the drive. This defined maximum angle of attack is typically one at which no stall occurs on the rotor blade at typical rotational speeds of the rotor device.

This is based upon the knowledge that, in particular, in the case of a sudden acceleration of the rotational speed of the rotor shaft, the torque can exceed a target torque at the new operating point by several times. As a result, without the proposed stop, the angle of attack of the rotor blade would increase to a higher value than at the new operating point, posing the risk that the rotor blade could stall prior to reaching the new operating point. At the point of stall, however, the profile drag and thus the rotor torque increase by several times. As a result, the rotor blade would remain in the stall region, leading to a new equilibrium state in the stalled state. The technical implementation of the proposed stop is relatively simple. It could, for example, be realized by a part produced using 3-D printing.

In a further development, it is provided that the mechanical coupling comprises a driver lever that is rigidly connected to a rotor blade (fastened to the second portion of the rotor device) and that is coupled to a driver portion of the first portion. This is a technically particularly simple implementation.

In a further development, the rotational movement of a rotor blade about the rotor blade axis is made possible by a twisting portion that is integral with the rotor blade. This is also a technically particularly simple and cost-effective implementation.

### BRIEF DESCRIPTION OF THE DRAWINGS

Embodiments of the invention are explained below with reference to the accompanying drawings. In the drawings:

FIG. 1 is a schematic plan view of a multicopter;

FIG. 2 is a perspectival exploded view of a first embodiment of a rotor device of the multicopter of FIG. 1;

FIG. 3 is a perspectival view of the rotor device of FIG. 2 in a first operating state;

FIG. 4 is a perspectival view of the rotor device of FIG. 2 in a second operating state;

FIG. 5 is a diagram in which a torque of a rotor shaft of one of the rotor devices of FIG. 2-4 is plotted against an angle of attack of a rotor blade;

FIG. 6 is a diagram in which a rotational speed of a rotor shaft of one of the rotor devices of FIG. 2-4 is plotted against an angle of attack of a rotor blade;

FIG. 7a is a diagram in which an angle of attack and a thrust of the rotor device of FIG. 2-4 are plotted against time;

FIG. 7b is a diagram in which a rotational speed of the rotor device of FIG. 2-4 is plotted against time;

FIG. 8 is a perspectival view of a second embodiment of a rotor device of the multicopter of FIG. 1;

FIG. 9 is a perspectival view of a third embodiment of a rotor device of the multicopter of FIG. 1;

FIG. 10 is a perspectival exploded view of the rotor device of FIG. 9;

FIG. 11 is a perspectival view of a fourth embodiment of a rotor device of the multicopter of FIG. 1;

FIG. 12 is a perspectival exploded view of the rotor device of FIG. 11;

FIG. 13 is a perspectival view of a fifth embodiment of a rotor device of the multicopter of FIG. 1;

FIG. 14 is a side view of the rotor device of FIG. 13; and

FIG. 15 is a plan view of the rotor device of FIG. 13.

### DETAILED DESCRIPTION OF THE PREFERRED EMBODIMENTS

In the following, functionally equivalent elements and regions in different embodiments and in different figures bear the same reference signs. They are usually explained in detail only upon their first mention. Furthermore, for reasons of clarity, it is possible that not all reference signs are included in all figures.

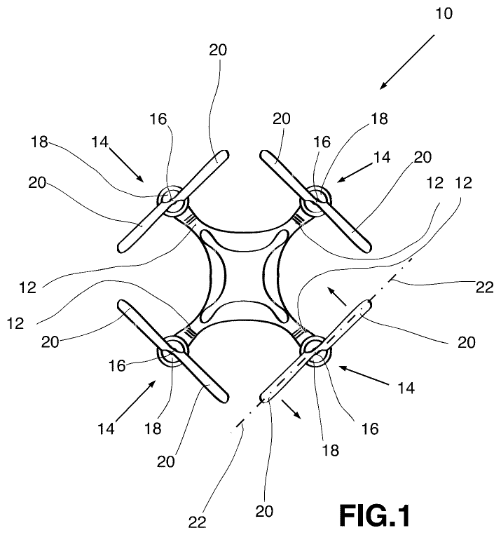

A multicopter is designated overall by the reference sign 10 in FIG. 1. It comprises a basic structure having, in the present case by way of example, four arms 12 extending radially outwards. At its end, in each case a rotor device 14 is arranged with an axis of rotation or rotor shaft 16 running perpendicular to the plane of the drawing, in the present case by way of example, a rotor head 18 coupled to the rotor shaft 16 and, likewise in the present case by way of example, two rotor blades 20 fastened to the rotor head 18. In principle, multicopters with fewer than or more than four rotor devices are also conceivable. As will be explained below, designs of rotor devices that do not have a discrete rotor head are also conceivable. Furthermore, designs of rotor devices that have only one rotor blade and a corresponding counterweight, or that have more than two rotor blades, are conceivable. In each case, the rotor blades 20 are rotatable relative to the rotor head 18 about a rotor blade axis 22. The rotor blade axis 22 is shown in FIG. 1 only for two rotor blades 20.

Each rotor device 14 also has an electric drive motor, but this is not visible in FIG. 1. The electric drive motor is connected to the rotor shaft 16. Furthermore, the multicopter 10 includes a control and regulating device, also not shown in FIG. 1, which can individually control the electric drive motors of the rotor devices 14 in order to control the multicopter in a known manner.

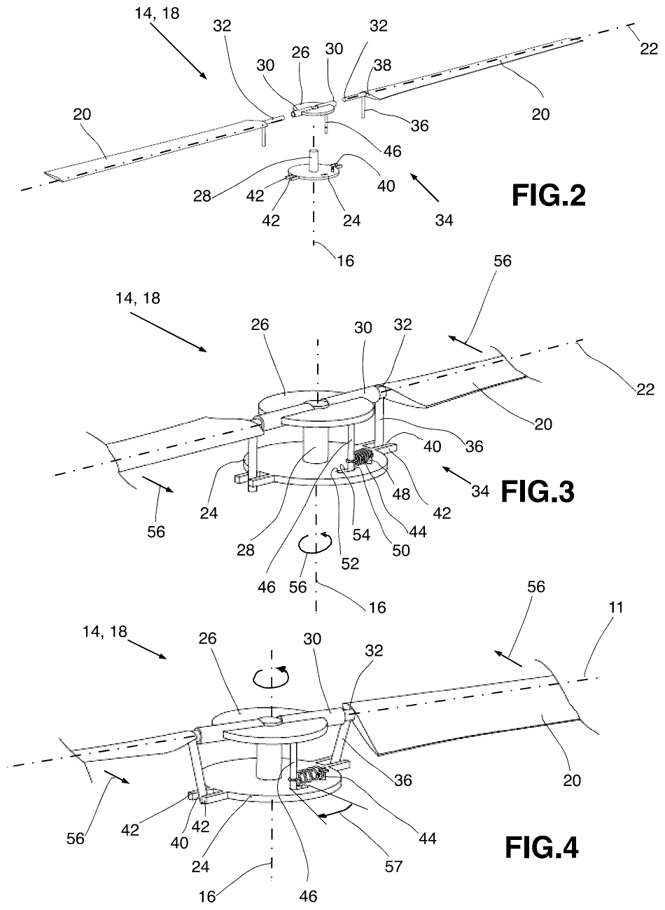

A first possible embodiment of the rotor devices 14 will now be explained with reference to FIG. 2-4 by way of example for a rotor device 14. The rotor device 14 or the rotor head 18 of the rotor device 14 comprises a lower first portion 24 and an upper second portion 26. Both portions 24 and 26 are designed in the present case by way of example as substantially circular disks. The lower first portion 24 has a central and upwardly pointing tubular receiving pin 28, into which an axle pin (not visible) of the second portion 26, which is also central and pointing downwards, engages. In this way, the second portion 26 is rotatably mounted on the first portion 24 and is arranged to be coaxially rotatable and movable therewith. Furthermore, the first portion 24 is firmly or rigidly connected to the rotor shaft 16, which is only indicated by a dash-dotted line.

The two rotor blades 20 are fastened to the second portion 26 and, as already mentioned above, are fastened so as to be rotatable relative to the rotor head 18 about the rotor blade axis 22 (or rotor blade axis 11 in FIG. 4). For this purpose, the second portion 26 has two tubular receiving pins 30 pointing in the radial direction, into which in each case an axle pin 32, pointing radially inwards, of a rotor blade 20 engages.

The rotor head 18 also includes two mechanical couplings 34, which in each case are assigned to a rotor blade 20. Since both mechanical couplings 34 are constructed identically, only one of the two mechanical couplings 34 is described below.

The mechanical coupling 34 comprises, in the present case by way of example, a driver lever 36 that is rigidly connected to the rotor blade 20. In the present case, the driver lever 36 protrudes downwards in the region of a root 38 of the rotor blade 20 orthogonally to the rotor blade axis 22 (or rotor blade axis 11 in FIG. 4) in the direction of the first portion 24. The mechanical coupling 34 further comprises a driver portion 40, which is coupled to the first portion 24.

In the present case by way of example, the driver portion 40 is designed as a receiving opening that is open radially outwards and is formed between two rod-shaped extensions 42 that extend radially outwards from the first portion 24. The driver lever 36 is received in the driver portion 40 with slight play. As will be shown later, the mechanical coupling 34 automatically and mechanically couples a torque-dependent position of the first portion 24 relative to the second portion 26 to a rotational position of the rotor blade 20 about the rotor blade axis 22 (or rotor blade axis 11 in FIG. 4) and thus to an angle of attack of the rotor blade 20.

The rotor device 14 further comprises an elastic coupling device 44 that elastically couples the second portion 26 to the first portion 24. In the present case, highly schematically and by way of example, the elastic coupling device 44 comprises a spiral spring, one end of which is connected to a rod-shaped holding portion 46 extending downwards from the second portion 26, and the other end of which is connected to a rod-shaped holding portion 48 extending upwards from the first portion 24. In the elastic coupling device 44 shown in the present case by way of example, it is a tension spring. The two holding portions 46 and 48 are thus pressed towards one another by the elastic coupling device 44.

The rotor device 14 further comprises a first stop 50 and a second stop 52. In the present case, the two stops 50 and 52 are formed by the axial end regions of a slot 54 extending in the circumferential direction, which is formed in the lower first portion 24 and into which the holding portion 46 engages. The relative rotational movement of the second portion 26 relative to the first portion 24 is thus limited to the angular range between the first stop 50 and the second stop 52.

The operation of the rotor device 14 will now be explained, in particular, with reference to FIGS. 3 and 4. FIG. 3 shows the rotor device 14 in a first operating state, in which the rotor shaft 16 and with it the two portions 24 and 26 of the rotor device 14 rotate at a constant speed driven by the electric drive motor mentioned above. The rotational movement is indicated in FIGS. 3 and 4 by arrows 56.

In the first operating state shown in FIG. 3, the holding portion 46 of the second portion 26 is pulled by the elastic coupling device 44 against the first stop 50. In this relative position of the two portions 24 and 26, the driver lever 36 protrudes downwards substantially parallel to the rotor shaft 16. Accordingly, the angle of attack (not shown) of the two rotor blades 20 is comparatively small. Thus, the first stop 50 has limited rotational movement of the two rotor blades 20 about the rotor blade axis 22 (or the rotor blade axis 11 in FIG. 4) in the direction of “smaller angle of attack.”

FIG. 4 shows the rotor device 14 in a second operating state immediately after an increase in the torque acting from the electric drive motor upon the rotor shaft 16 and thus upon the first portion 24 (“drive torque”). Due to the increased drive torque, the lower first portion 24, which is rigidly coupled to the rotor shaft 16, twists in advance relative to the second portion 26 in the direction of rotation 56. As a result, the elastic coupling device 44 is stretched, and the holding portion 46 is moved in the slot 54 against the second stop 52, corresponding to an arrow 57 in FIG. 4.

Due to the relative twisting between the first portion 24 and the second portion 26, the driver lever 36 is carried along by the driver portion 40 (automatic mechanical coupling), as a result of which the particular rotor blade 20 is twisted about the rotor blade axis 11 so that the angle of attack of the particular rotor blade 20 is increased. Thus, the second stop 52 limits a rotational movement of the two rotor blades 20 about the rotor blade axis 11 in the direction of “larger angle of attack.” The second stop 52 is selected so that the maximum aerodynamically sensible angle of attack of the rotor blades 20 is prevented from being exceeded.

Due to the larger angle of attack, a higher thrust of the rotor device 14 arises. Furthermore, due to the increased angle of attack of the two rotor blades 20, the aerodynamic drag of the two rotor blades 20 is increased, as a result of which a counter-torque is exerted on the rotor shaft 16, which is opposite to the drive torque exerted by the electric motor drive on the rotor shaft 16. This means that even an abrupt increase in the drive torque leads, if at all, only to a comparatively small increase in the rotational speed of the rotor shaft 16.

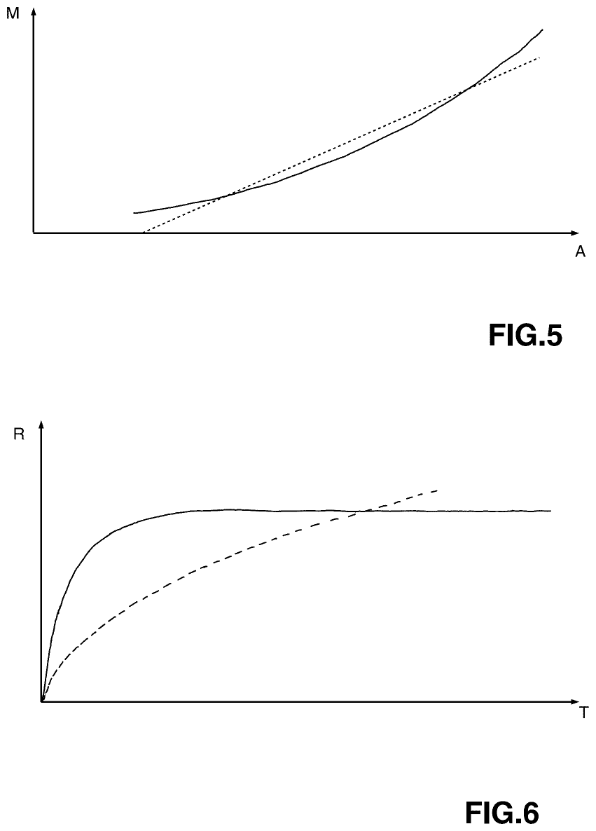

How the rotational speed and thrust behave when the drive torque changes depends to a considerable extent upon the characteristics of the elastic coupling device 44. A rotational speed that is approximately constant over a wide range can be achieved, even in the event of an abrupt change in the drive torque, with an elastic coupling device 44 that has at least approximately linear elastic behavior, i.e., and at least approximately linear spring characteristic curve. This is shown in the diagrams in FIGS. 5 and 6, in which the drive torque M on the rotor shaft 16 or the first portion 24 is plotted against the angle of attack A of the rotor blades 20 (FIG. 5), and the rotational speed R of the rotor shaft 16 or the first portion 24 is plotted against the thrust T (FIG. 6). In FIG. 5, the actual torque is shown as a solid line, whereas the dashed line represents the idealized approximation of the actual torque by linear spring elements. In FIG. 6, the actual rotational speed of the rotor device 14 of FIG. 1-4 is plotted as a solid line, and for a conventional propeller as a dashed line.

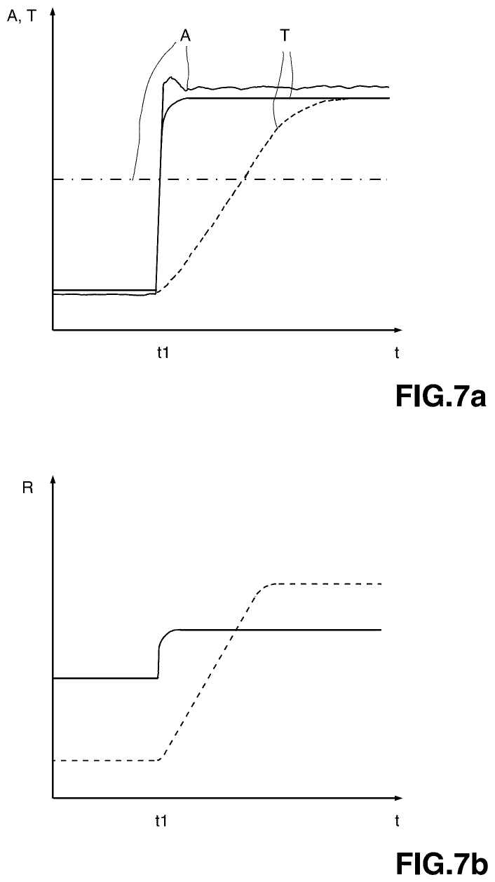

If an even more constant rotational speed is desired when the drive torque changes, this can be achieved with an elastic coupling device 44, which has a progressive elastic behavior, i.e., a progressive spring characteristic curve. This is shown in FIGS. 7a and 7b, in which the angle of attack A and the thrust T are plotted against time t in one diagram, and the rotational speed R is plotted against time t in the other diagram. The abrupt change in the drive torque shown in the present case by way of example occurs at a point in time t1. The solid lines correspond to the behavior of the rotor device 14 of FIG. 1-4, and the dashed lines to a conventional propeller.

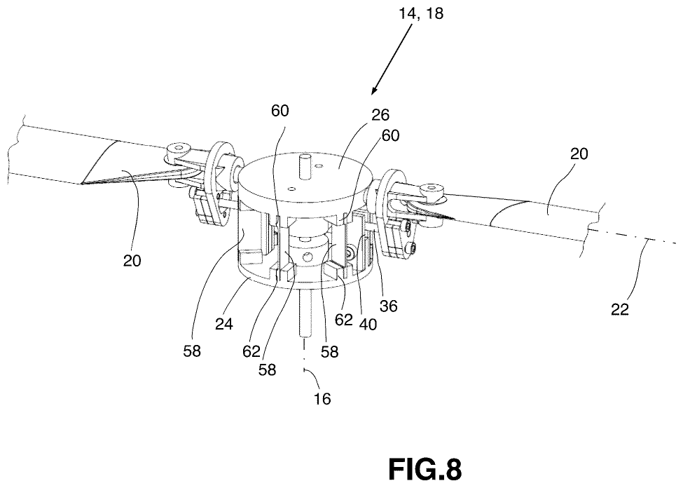

An alternative embodiment of a rotor device 14 is shown in FIG. 8. This differs from the embodiment of FIG. 2-4 primarily in the configuration of the elastic coupling device 44. In the present case and highly by way of example, this comprises a plurality of elastic bending elements 58, which in turn are arranged, in the present case highly by way of example, in a manner evenly distributed in the circumferential direction of the portions 24 and 26. The bending elements 58 are designed in the form of rectangular bending plates, e.g., made of GRP or CFRP, which are flat and level in the unloaded state, whose longitudinal axis runs parallel to the axis of the rotor shaft 16, and whose planes are aligned radially. An upper end of a bending element 58 in FIG. 8 is received in a receiving portion 60 of the upper second portion 26 of the rotor device 14 and fastened there. A lower end of a bending element 58 in FIG. 8 is received in a receiving portion 62 of the lower first portion 24 of the rotor device 14 and fastened there.

When there is a change in the drive torque acting upon the rotor shaft 16 and thus upon the lower first portion 24 of the rotor device 14, the bending elements 58 are bent from their straight, flat shape shown in FIG. 8 into a curved, bent shape by the lower first portion 24, which leads in the direction of rotation 56.

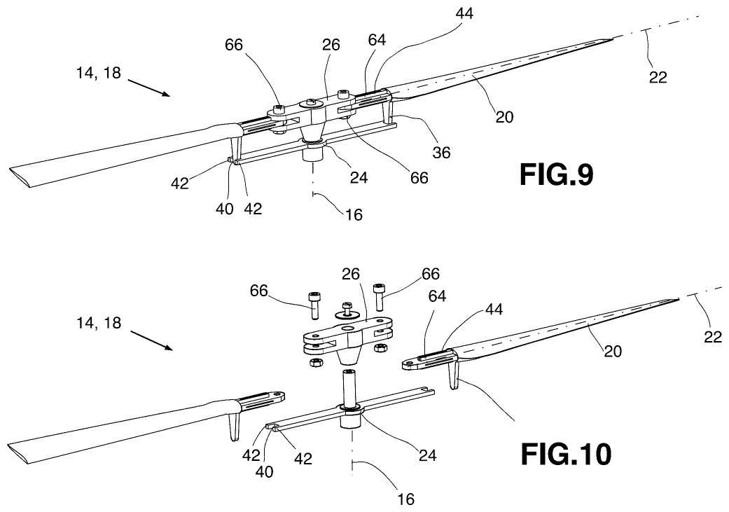

In the embodiment of FIGS. 9 and 10, the rotational movement of a rotor blade 20 is made possible by a twisting portion 64 that is integral with the rotor blade 20. This is elastically twisted when the rotor blade 20 rotates about the rotor blade axis 22. The twisting portion 64 is preferably made of a corresponding plastic material. Due to its elasticity, the twisting portion 64 also acts as an elastic coupling device 44, as described above. The two rotor blades 20 are fastened to the upper second portion 26 of the rotor head 18 in the embodiment shown by way of example in FIGS. 9 and 10 by means of screws 66.

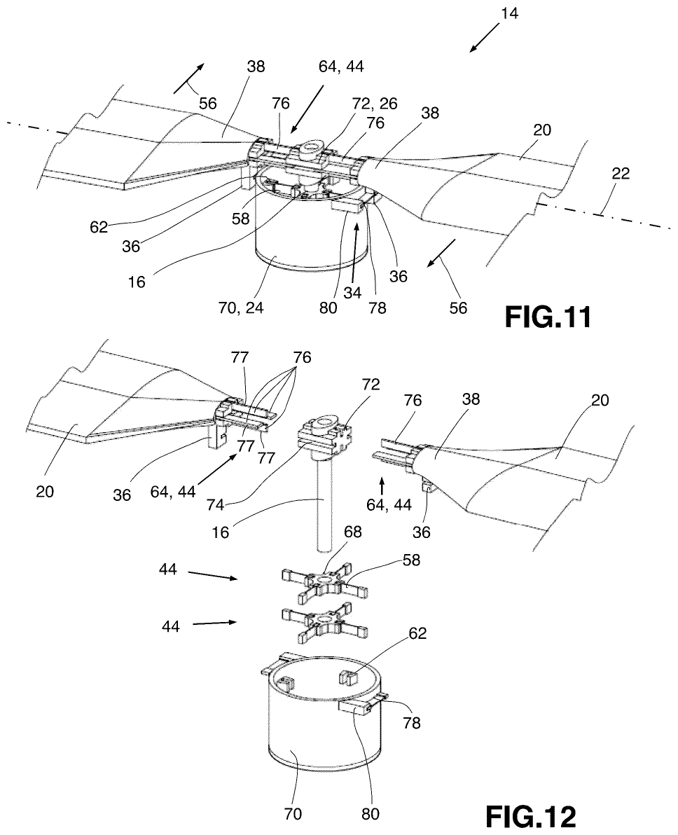

In the embodiment of FIGS. 11 and 12, two star-shaped, elastic coupling devices 44 are pushed onto the rotor shaft 16 and rigidly fastened thereto—for example, by gluing. Each of the two elastic coupling devices 44 has a central body 68, which is pushed onto the rotor shaft 16 and glued to it. Four plate-shaped, elongated bending elements 58 extend radially outwards in a star shape from the central body 68. These can, for example, be made of a thin plastic material, possibly with fiber reinforcement, such as glass fiber or carbon fiber.

A hollow cylindrical coupling ring 70 is firmly connectable to the drive motor (not shown), which can, for example, be a brushless electric motor, and to its rotating portion (not shown). This has 2×4 receiving portions 62 on its inner side for receiving the protruding ends of the bending elements 58. The bending elements 58 can be glued into the receiving portions 62, for example. In this way, the rotor shaft 16 is elastically connected to the coupling ring 70 via the bending elements 58.

A receiving portion 72 is rigidly fastened to the upper end of the rotor shaft 16 in FIGS. 11 and 12, which receiving portion has receiving slots 74 running transversely to the longitudinal axis of the rotor shaft 16. In each case, four leaf-like, elongated fastening tongues 76 of two rotor blades 20 can engage in these. The four fastening tongues 76 are, for example, glued into the receiving slots 74 that complement them.

The fastening tongues 76 extend from the root 38 of a rotor blade 20 at least approximately parallel to the rotor blade axis 22 such that a radially outer narrow side 77 of the fastening tongues 76 lies on an imaginary, enveloping cylinder wall. Or, in other words, the leaf planes of two opposite fastening tongues 76 lie in the same plane, whereas the leaf planes of two adjacent connecting tongues 76 viewed in the circumferential direction are orthogonal to one another. It is understood that, in another embodiment, more than or fewer than four fastening tongues may be present, or a completely different form of torsionally elastic but flexurally rigid coupling may be present.

The fastening tongues 76 are made of a thin plastic material, optionally with a fiber reinforcement—for example, glass fibers or carbon fibers. They can be very thin, for example, in the range of a thickness of only 0.2 mm. Due to the fastening tongues 76, the two rotor blades 20 are connected to the receiving portion 72 in a manner that is highly flexurally rigid about axes orthogonal to the rotor blade axis 22 on the one hand, but, on the other, is elastically twistable about the rotor blade axis 22. In this respect, the fastening tongues 76 form the twisting portion 64 already mentioned above.

The driver lever 36 extends orthogonally to the rotor blade axis 22 from the root 38 of a rotor blade 20, the protruding end of which driver lever is connected in the present case by way of example to a bending element 78 that extends on the outer side of the coupling ring 70 from a radially protruding fastening portion 80 approximately in the circumferential direction of the coupling ring 70.

During operation, the coupling ring 70 is set in rotation by the drive motor, and the rotor shaft 16 and with it the two rotor blades 20 are also set in rotation via the elastic coupling devices 44. If the torque of the drive motor is increased, the coupling ring 70 moves ahead of the receiving portion 72, as already explained above in connection with the other embodiments. The bending elements 58 are bent in the same direction.

Due to the change in the relative position between coupling ring 70, on the one hand, and the receiving portion 72, on the other, and due to the mechanical coupling 34 of the rotor blades 20 to the coupling ring 70 by means of the driver lever 36, the two rotor blades 20 twist about the rotor blade axis 22 in the direction of larger angles of attack. In this respect, the coupling ring 70 forms the “first portion 24” described above, and the receiving portion 72 forms the “second portion 26” mentioned above.

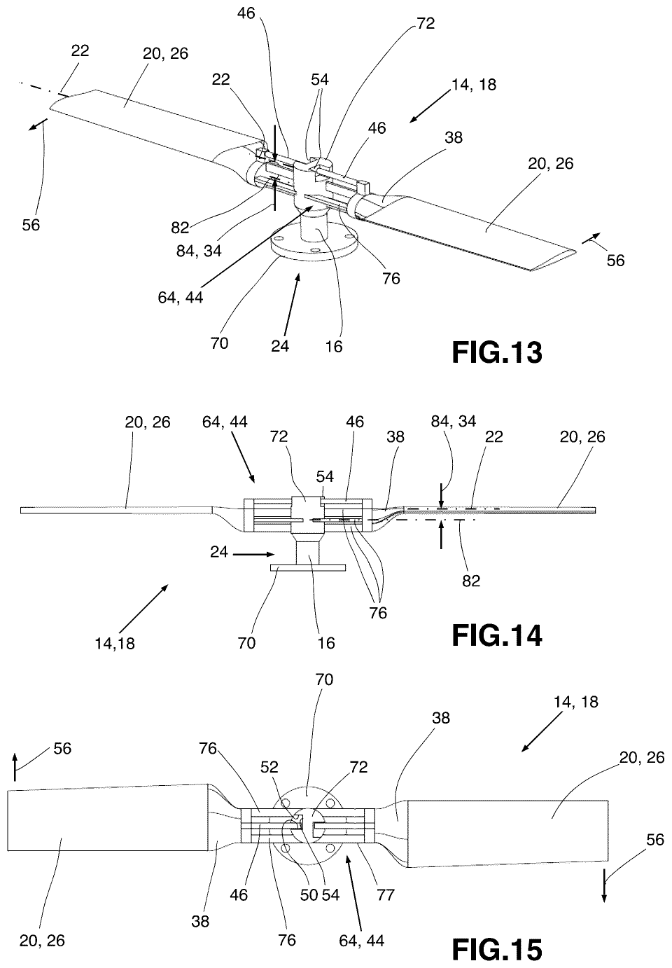

In the embodiment of a rotor device 14 shown in FIG. 13-15, the rotor shaft 16 is fastened to a flat fastening flange 70, which in turn can be connected to the rotating portion of the drive motor (not shown). As in the embodiment of FIG. 11-12, the two rotor blades 20 are connected to the receiving portion 72 via the fastening tongues 76. In a particularly preferred embodiment, the fastening flange 70, rotor blades 20, fastening tongues 76, and receiving portion 72/rotor shaft 16 are produced as an integral part, e.g., by an injection-molding process or by 3-D printing—for example, from plastic.

A special feature of the embodiment of FIG. 13-15 is that the rotor blade axis 20, relative to a central axis 82 of the unit formed from the four fastening tongues 76, is arranged offset upwards by a gap 84 in a direction parallel to the rotor shaft 16. In an upper, as shown in the figures, end face of the rotor shaft 16, two slightly laterally offset recesses 54 are present, in which a pin 46 extending parallel to the rotor blade axis 22 from the root 38 towards the rotor shaft 16 engages.

In turn, the drive motor (not shown) causes the fastening flange 70 to be set in rotation, and with this, the two rotor blades 20, are set in rotation via the rotor shaft 16. When the torque increases, the rotor blades 22 tilt backwards against the direction of rotation 56 due to the gap 84 about the central axis 82, in turn due to the inertia and the air drag forces, as a result of which an increase in the angle of attack arises. This rotation is in turn made possible by the elastic fastening tongues 76, which also generate the necessary restoring force against the tilting direction of the rotor blades 20.

In this respect, the fastening tongues 76 also here form the twisting portion 64 already mentioned above, into which the elastic coupling device 44 is integrated. In the present case, the entirety of the fastening flange 70 and the rotor shaft 16 forms the rotatably driven first portion 24 mentioned above, whereas the two rotor blades 20 form or are comprised by the second portion 26 mentioned above, which is movable, relative to the first portion 24, about an axis that runs parallel to the axis of rotation or rotary shaft 16, due to the tilting movement.

The mechanical coupling 34, which couples the relative position of the first portion 24 relative to the second portion 26 to a rotational position of the rotor blade 20 about the rotor blade axis 22, is realized in the present case by the gap 84 between the two axes 22 and 82.

With their lateral ends, the recesses 54 form first and second stops 50 and 52, by which the maximum and the minimum tilt angles and thus the maximum and minimum angles of attack of the rotor blades 20 are limited.

What is claimed is:

1. A multicopter, comprising:
a plurality of rotor devices;
wherein a rotor device from the plurality of rotor devices comprises at least one rotor blade, which is configured to be rotatable about a rotor blade axis;
wherein the rotor device has:
a first portion rotatably driven about an axis of rotation;
a second portion, which is configured to be movable relative to the first portion about an axis that runs coaxially with the axis of rotation and to which the rotor blade is fastened or that comprises the rotor blade;
wherein a relative position of the second portion to the first portion depends upon a torque with which the first portion is driven, and a mechanical coupling, which couples the relative position of the first portion relative to the second portion to a rotational position of the rotor blade about the rotor blade axis;
wherein the rotor device comprises a restoring device, which at least temporarily presses the rotor blade in the direction of an initial position with regard to its rotational position;
wherein the restoring device is in the form of an elastic coupling device that elastically and at least indirectly couples the second portion to the first portion; and
wherein the elastic coupling device has a progressive spring characteristic curve.

2. The multicopter according to claim 1, wherein the elastic coupling device comprises at least one elastic bending element, in particular, comprises a plurality of elastic bending elements, that are preferably arranged in a manner evenly distributed as seen in the circumferential direction of the first portion, wherein the elastic bending element or the elastic bending elements is or are connected at one end to the first portion and at the other end to the second portion.

3. The multicopter according to claim 1, wherein the rotor device comprises a first stop that at least indirectly limits a rotational movement of the rotor blade about the rotor blade axis in the direction of a smaller angle of attack.

4. The multicopter according to claim 1, wherein the rotor device comprises a second stop that at least indirectly limits a rotational movement of the rotor blade about the rotor blade axis in the direction of a larger angle of attack.

5. The multicopter according to claim 1, wherein the mechanical coupling comprises a driver lever that is rigidly connected to the rotor blade and that is coupled to a driver portion of the first portion.

6. The multicopter according to claim 1, wherein the rotational movement of the rotor blade about the rotor blade axis is made possible by a twisting portion that is integral with the rotor blade.
